(19) United States
(12) Patent Application Publication
(10) Pub. No.: US 2025/0023803 A1
(43) Pub. Date: Jan. 16, 2025

(54) METHOD AND DEVICE FOR SUPPORTING A MULTIPORT CONNECTION

(71) Applicant: Telefonaktiebolaget LM Ericsson (publ), Stockholm (SE)

(72) Inventors: Luciano CURRARINO, Levanto (IT); Stefano TRUCCO, Montoggio (IT)

(21) Appl. No.: 18/707,508

(22) PCT Filed: Nov. 5, 2021
(86) PCT No.: PCT/EP2021/080806

§ 371 Date: May 3, 2024

(51) Int. Cl. H04L 41/50; H04L 41/22

(52) U.S. Cl. CPC H04L 41/5077; H04L 41/22

(57) ABSTRACT

A method and a device for supporting establishing a connection between at least two pairs of physical ports (103, 113, 107, 117) on two network devices (101, 111), the at least two pairs of physical ports (103, 113, 107, 117) belonging to the same multiport connection. A visual indication of the at least two pairs of physical ports (103, 113, 107, 117) on the front panel of the two network devices (101, 111) is provided. The visual indication may be a same color, or a same blink frequency of a LED associated with a physical port; or an indication generated by an augmented-reality device.

### TECHNICAL FIELD

The invention relates to a device and a method for supporting a multiport connection, and corresponding computer program and computer program product.

### BACKGROUND

Link aggregation combines (aggregates) multiple network connections in parallel. The aggregation generally involves two or more links between two physical devices, such as two servers, two switches, a server to a switch, or various other combinations. Standards, such as Link Aggregation Control Protocol (LACP), provide the combination of the two or more links into a single logical link. Aggregating multiple links between physical interfaces/ports creates a single logical point-to-point link or a Link Aggregation Group (LAG).

Link aggregation increases bandwidth since a LAG is treated as a single physical port. LACP provides redundancy, when one interface fails, the remaining interfaces continue to carry the traffic, ensuring continuity within a network; provides a load-balance across the multiple links.

The link between two physical interfaces/ports needs to be correctly set up, otherwise the traffic cannot be assured. At present, two physical ports associated with a service are connected by a craft person by getting indexes of the two physical ports from a Local Craft Terminal (LCT); finding the corresponding indexes in the front panel of the two network devices; and connecting the two physical ports with the corresponding indexes via a cable. In actual network environment, when a craft person sets up a LAG connection in central office, a street cabinet or similar, he sees several (often dozens) front panels/faceplates of network devices and may connect cables to wrong physical ports.

### SUMMARY

Accordingly, the solution disclosed in this document seeks to preferably mitigate, alleviate, or eliminate one or more of the disadvantages mentioned above singly or in any combination.

To achieve said object, according to a first aspect of the present invention there is provided a method for supporting establishing a connection between at least two pairs of physical ports on two network devices, the at least two pairs of physical ports belonging to a same multiport connection. The method of the first aspect comprises determining a service requiring a multiport connection based on at least two pairs of physical ports. The method further comprises obtaining identifiers of the at least two pairs of physical ports on the two network devices based on the determined service. The method further comprises sending control signals to user interfaces associated with the two network devices to indicate the at least two pairs of physical ports to be connected based on the obtained physical port identifiers. This simplifies how to connect several ports on one device to several ports on another device, reducing time and errors.

According to a second aspect of the present invention, there is provided a device for supporting a multiport connection. The device comprises a processor and a memory, the memory having stored thereon instructions executable by the processor. The instructions, when executed by the processor, cause the device to determine a service requiring a multiport connection based on at least two pairs of physical ports. The instructions, when executed by the processor, cause the device to obtain identifiers of at least two pairs of physical ports belonging to the multiport connection on two network devices based on the determined service. The instructions, when executed by the processor, cause the device to send control signals to user interfaces associated with the two network devices to indicate the at least two pairs of physical ports to be connected based on the obtained physical port identifiers.

According to a third aspect of the present invention there is provided a computer program comprising instructions which, when run in a processing unit on a device, cause the device to determine a service requiring a multiport connection based on at least two pairs of physical ports; obtain identifiers of at least two pairs of physical ports belonging to the multiport connection on two network devices based on the determined service; and send control signals to user interfaces associated with the two network devices to indicate the at least two pairs of physical ports to be connected based on the obtained physical port identifiers.

According to a fourth aspect of the present invention there is provided a computer program product comprising a computer readable storage medium on which a computer program, as mentioned above, is stored.

In an embodiment, the user interfaces associated with the two network devices comprise faceplates of the two network devices and the control signals turn on Light Emitting Diodes (LEDs) pairwise associated with the at least two pairs of physical ports based on the obtained physical port identifiers.

In an embodiment, the user interfaces associated with the two network devices comprise at least one augmented-reality device and the operation of sending comprises sending control signals to the at least one augmented-reality device to generate an augmented reality image by overlaying the at least two pairs of physical ports with a graphical indication. This provides simplification and reduction of time and error also if the two network devices are not equipped with LEDs.

In an embodiment, the user interfaces associated with the two network devices comprise at least one augmented-reality device and the operation of sending comprises sending control signals to the at least one augmented-reality device to present the at least two pairs of physical ports and a graphical indication if a camera of the at least one augmented-reality device captures the at least two pairs of physical ports.

In an embodiment, the connection between the at least two pairs of physical ports forms a Link Aggregation Group (LAG).

In an embodiment, the operation of sending the control signals to the two network devices is carried out by a Local Craft Terminal (LCT).

In an embodiment, the control signals assign a same LED color pairwise to the identifiers.

In an embodiment, the method may comprise showing in a GUI the identifiers and information representing the same LED color.

In an embodiment, the control signals assign a same LED blink frequency pairwise to the identifiers.

In an embodiment, the method may comprise showing in a GUI the identifiers and information representing the same LED blink frequency.

In an embodiment, the method may comprise turning off a first pair of LEDs associated with a first pair of physical ports if the physical ports in the first pair are connected; and turning on a further pair of LEDs associated with a further pair of physical ports to be connected.

In an embodiment, the method may comprise showing at a same time at least a first graphical indication for a first pair of physical ports to be connected and a second graphical indication for a second pair of physical ports to be connected.

In an embodiment, the method may comprise showing a first graphical indication of a first pair of physical ports until the first pair of physical ports is not connected; stop showing the first graphical indication if the first pair of physical ports is connected; and showing a second graphical indication of a second pair of physical ports to be connected.

### BRIEF DESCRIPTION OF THE DRAWINGS

For better understanding of the present disclosure, and to show more readily how the invention may be carried into effect, reference will now be made, by way of example, to the following drawings, in which:

FIG. 1 shows an example of a multiport connection;

FIG. 2 shows a flowchart illustrating a method performed by a device according to embodiments;

FIG. 3a shows an example of a graphical user interfaces (GUI) showing services requiring a multiport connection between two network devices, and colors assigned to identifiers of three pairs of physical ports on the two network devices according to embodiments;

FIG. 3b shows an example of faceplates and physical ports with labels of two network devices;

FIG. 4 is a block diagram depicting a device according to an embodiment; and

FIG. 5 is a block diagram depicting units of a device according to an embodiment.

### DETAILED DESCRIPTION

Embodiments will be illustrated herein with reference to the accompanying drawings. These embodiments are provided by way of example so that this disclosure will be thorough and complete, and will fully convey the scope of the inventive concept to those skilled in the art.

A craft person, that has to connect a pair of physical ports associated with a service on two network devices, needs to perform the following steps: select the service, for example from a graphical user interfaces (GUI) of a local craft terminal (LCT); retrieve identifiers of internal ports associated with the service (i.e., the physical ports to connect); find the identifiers in the front panel/faceplate of the two network devices; and connect the physical ports associated with the identifiers via a cable.

These steps are time consuming and error prone. The identifiers shown in the GUI may not correspond with the identifiers in the front panel of the network devices. Moreover, being the steps performed by a craft person, a cable may be connected to the wrong physical ports and the connection may be configured incorrectly (may not work).

These problems are exacerbated when setting up a LAG connection when several ports on one device need to be connected to several ports on another device. This is even more complex when the two devices are located in two different locations and the connection is set up by two field engineers communicating over a phone. Doing it in a room or a street cabinet with large number of devices, ports and cables only adds complexity and increase the likelihood of error.

To overcome these problems, the solution to be disclosed, in its embodiments, provides a visual indication of the physical ports on the front panel/faceplate of the two network devices to help a craft person in connecting physical ports belonging to a same multiport connection. The visual indication may be a same color, or a same blink frequency of a light-emitting diode (LED) associated with a physical port; or an indication generated by an augmented-reality device.

The present invention in its embodiments simplifies operations and reduces time for connecting at least a pair of physical ports of a same multiport connection during installation, configuration, maintenance, or troubleshooting.

Beside a LAG connection scenario, the solution to be disclosed may also be used in case of connection of a single port on a device to a single port of another device. The two devices may be located in two different locations and the connection is set up by two field engineers communicating over a phone.

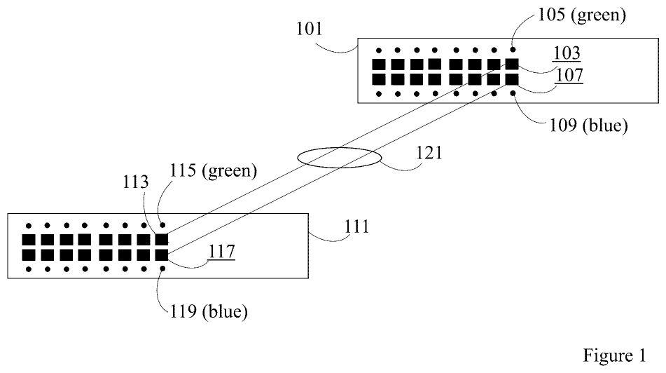

FIG. 1 shows an example scenario of a multiport connection. FIG. 1 shows a front panel/faceplate of two multiport network devices 101, 111, wherein a port 103 is associated with a LED 105. The LED 105 may be RGB/RGB+W/RGBW or single-color. According to an embodiment, the network device 101, 111 may not be equipped with a LED associated with a physical port. In FIG. 1, two pairs of physical ports, 103 and 113, 107 and 117, are connected and belong to a Link Aggregation Group (LAG), 121.

A network device 101, 111 may be a router, a switch, a Baseband Unit (BBU), a radio access network device connected via a fronthaul network, or any network device with a plurality of physical port. The link connecting a pair of physical ports may be a physical, hardwired cable that provides a direct connection between the two physical ports such as fiber, coaxial, copper, plain old telephone service (POTS).

A LCT may be connected to a network device and provide a GUI for management purposes of the network devices involved in the cross-connection.

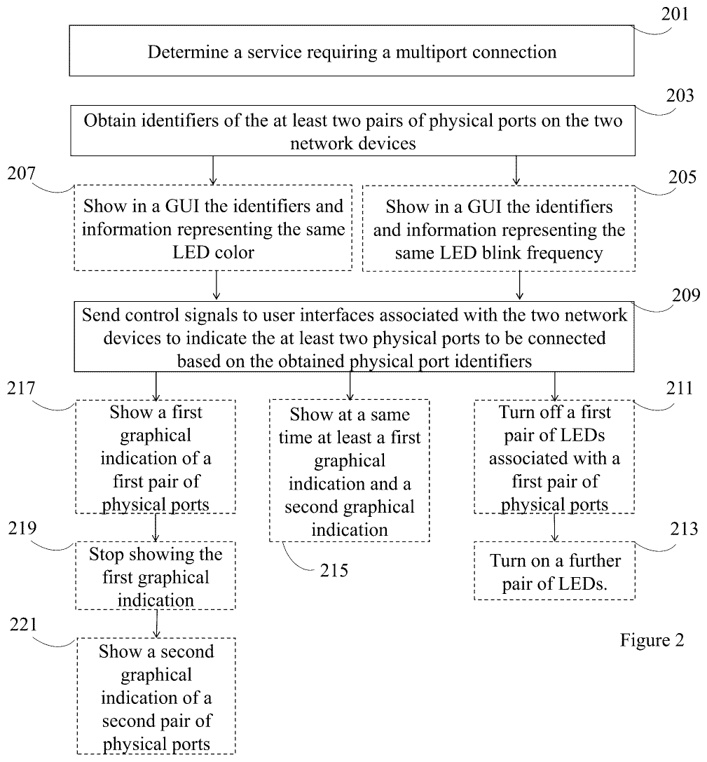

FIG. 2 shows embodiments of a method for supporting establishing a connection between at least two pairs of physical ports (103, 113, and 107, 117) on two network devices 101, 111, wherein the at least two pairs of physical ports (103, 113, and 107, 117) belong to a same multiport connection. In one embodiment, the method may be carried out by a device 400.

Referring to the method in FIG. 2, in step 201, the method comprises determining 201 a service requiring the multiport connection. The service with an identifier may be defined by a network operator in advance and then a craft person may enter the identifier of the service into LCT for identifying the physical ports to connect; or the service may be defined by the craft person when using the LCT (e.g., when doing troubleshooting, the craft person realizes that a new service requiring link aggregation needs to be set up).

In step 203, the method comprises obtaining identifiers of the at least two physical ports on the two network devices 101, 111 based on the determined service. The identifiers may be a string with a human-readable name or numbers. If the service is defined in advance by a network operator, also the physical ports 103, 113 to be cross connected are identified when the service is defined, and their identifiers need to be read from a table or other document. If the service is defined (set up) by the craft person ad hoc, the physical ports 103, 113 are identified in the process of setting up the service (and also in this case, the identifiers need to be read from a table). According to an embodiment, the table is provided by a GUI of an LCT.

In step 209, the method comprises sending control signals to user interfaces associated with the two network devices 101, 111 to indicate the at least two pairs of physical ports (103, 113, and 107, 117) to be connected based on the obtained physical port identifiers. The control signals may be sent over a management interconnection (e.g., data communication network (DCN)). According to an optional embodiment, the operation of sending the control signals to the two network devices 101, 111 may be carried out by a LCT or a Command Line Interface (CLI).

The user interface generates the visual indication based on the received control signals and a craft person may use the visual indication to identify the physical ports (103, 113, and 107, 117) on the two network devices to connect. According to an embodiment, the connection between the at least two pairs of physical ports (103, 113, and 107, 117) forms a LAG (121). Therefore, the connection of the first pair of physical ports is combined with the connection of the second pair of physical ports into a single logical link.

The visual indication may be a same color, or a same blink frequency of a LED associated with a physical port; or a graphical indication generated by an augmented-reality device. Embodiments relating these alternatives are described in the following.

According to an embodiment, the user interfaces associated with the two network devices 101, 111 comprise faceplates of the two network devices. If the faceplate comprises LEDs associated with the physical ports (preferably each physical port has its own LED), the control signals cause turning on the LEDs (105, 115, and 109, 119) pairwise associated with the at least two pairs of physical ports (103, 113, and 107, 117) based on the obtained physical port identifiers. Pairwise, here, means that a pair of LEDs each of the two LEDs being on a different network device. The control signals may assign a same LED color pairwise to the identifiers. A LED color is a color that will be emitted by a LED. All the LED color pairwise or a subset may be turned on at the same time.

According to an embodiment, a GUI may show 207 the identifiers and information representing the same LED color. This embodiment may be used if the LEDs are RGB/RGB+W/RGBW, so a different color may be assigned to each pair. An operator/craft person may choose a color for a pair, or the color may be automatically assigned.

For example, referring to FIG. 1 in case of two pairs of physical ports (103, 113, and 107, 117) with corresponding RGB LEDs (105, 115, and 109, 119) of the first and second network devices: green is assigned to the first pair of physical ports 103, 113 and blue is assigned to the second pair of physical ports 107, 117. Therefore, the first and second LEDs 105 and 109 on the faceplate of the first network device 101 will emit green and blue light, respectively; and the first and second LEDs 115 and 119 on the faceplate of the second network device 111 will emit green and blue light, respectively. Looking at the colors, a craft person will understand that the physical ports 103 and 113 associated with the green LED need to be connected, and the physical ports 107 and 117 associated with the blue LED need to be connected.

Alternatively, the control signals assign a same LED blink frequency pairwise to the identifiers of the at least two pairs of physical ports (103, 113, and 107, 117). A LED blink frequency is a number of times per second the LED blinks. All the LED blink frequency pairwise or a subset may be turned on at the same time. This embodiment may be used if the LEDs are RGB/RGB+W/RGBW or single-color. The GUI may show 205 the identifiers and information representing the same LED blink frequency. An operator/craft person may choose a LED blink frequency for a pair, or the LED blink frequency may be automatically assigned.

For example, referring to FIG. 1, 1 Hz is assigned to the first pair of physical ports 103, 113 and 0.25 is assigned to the second pair of physical ports 107, 117. Looking at the LED blink frequencies, a craft person will understand that physical ports 103 and 113 associated with the 1 Hz LED need to be connected, and physical ports 107 and 117 associated with the 0.25 Hz LED need to be connected. A person skilled in the art would understand that actual frequencies of the blinking are not important. It is important, though, that the frequencies are different enough to be distinguished with human eye.

According to an optional embodiment, a first pair of LEDs 105, 115 associated with a first pair of physical ports 103, 113 is turned on and remaining pairs of LEDs associated with remaining pairs of physical ports are left switched off. In step 211, the first pair of LEDs 105, 115 is turned off if the physical ports 103, 113 of the first pair are connected; then in step 213, a further pair of LEDs 109, 119 associated with a further pair of physical ports 107, 117 to be connected is turned on. In other words, only one pair of LEDs is switched-on at a time and is then switched-off when ports are connected, then the next pair of LEDs is switched-on and so on.

If the network devices are not equipped with LEDs or, as an alternative to the use of LEDs for a device with LED, a graphical indication generated by an augmented-reality device may be used to identify the physical ports to connect. According to an embodiment, the user interfaces associated with the two network devices 101, 111 comprise at least one augmented-reality device. An augmented-reality device may be a device, such as a phone or a visor, configured to provide an augmented reality experience.

The control signals are sent to the at least one augmented-reality device to generate an image by overlaying the at least two pairs of physical ports 103, 113, and 107, 117 with a graphical indication onto an image of a front panel of at least one of the network devices captured by the augmented-reality device. A graphical indication may be for example a color, a mark, a symbol. According to an embodiment, the at least two pairs of physical ports and a graphical indication are shown in an augmented reality image if the at least one augmented-reality device captures the at least two pairs physical ports. For example, the augmented reality image is generated if the craft person is positioned in front of one or both the two network devices.

The graphical indications for the ports of a network device may be
shown all at the same time, i.e. showing 215 at a same time at least a first graphical indication for a first pair of physical ports 103, 113 to be connected and a second graphical indication for a second pair of physical ports 107, 117 to be connected; or
only one pair of graphical indications is shown at a time and is then replaced with the next pair of graphical indications when the physical ports are connected, and so on, i.e., showing 217 a first graphical indication of a first pair of physical ports 103, 113 until the first pair of physical ports is not connected; stop showing 219 the first graphical indication if the first pair of physical ports 103, 113 is connected; and showing 221 a second graphical indication of a second pair of physical ports 107, 117 to be connected.

For example, an application for phones may use the phone camera to capture a network device (or at least its front panel or a part of the front panel) and highlight the physical ports associated with the service with different colors as configured by operator/craft person via LCT.

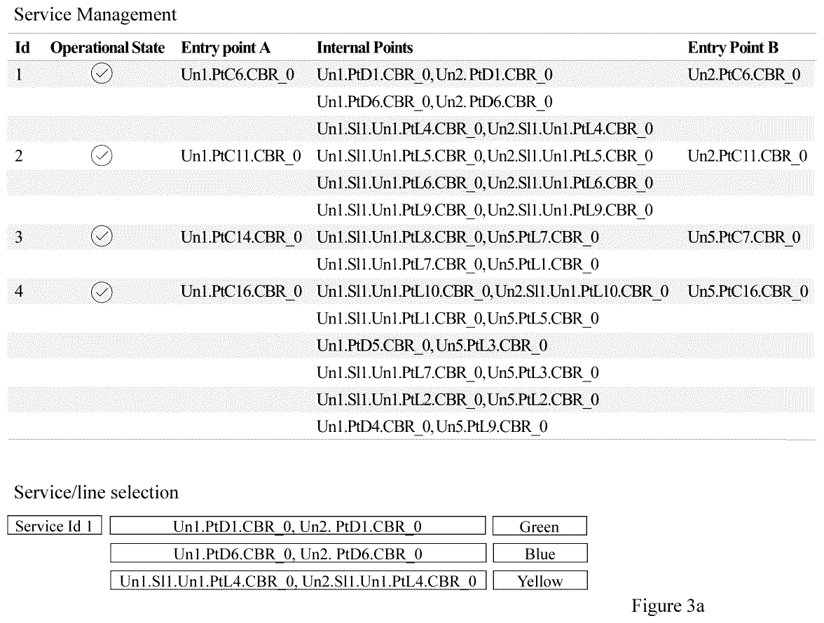

FIG. 3a shows an example scenario of a GUI showing four services and corresponding multiport connections of two network devices (Unit1 and Unit2). The two network devices (or units) 301, 311 are shown in FIG. 3b.

The top part of FIG. 3a shows an identifier of the service (1-4) in the first column, the second column shows the operational state of the service (e.g., if the service is “up” or “down”), the third and fifth columns shows identifiers of entry points, and the fourth column shown the connections between internal ports. The entry points are client ports in a fronthaul network, i.e. ports towards another equipment that can be, for example, antennas on one side and baseband unit on the other side

The two units 301 and 311 in FIG. 3b are identified with 1 and 2, respectively. Both units have a slot 305, 315 identified with the number 1 with six physical ports 303, 313 labeled with the identifiers L1-L6. Both units have six further physical ports 303, 313 labeled with the identifiers D1-D6.

According to the table in the top part of FIG. 3a, traffic of service 1, that might be for example 25 Gbps, is split across three pairs of physical ports connected as follows:
Un1.PtD1 and Un2.PtD1,
Un1.PtD6 and Un2.PtD6,
Un1.Sl1.Un1.PtL4 and Un2.Sl1.Un1.PtL4.

Un{v}.Pt{w} and Un{v}.Sl{x}.Un{y}.Pt{w} are examples of identifiers provided by the LCT, wherein
Un{v} indicates the network device {v}, wherein {v} is a corresponding identifier for the network device (e.g., 1 or 2),
Pt{w} indicates the physical port {w}, wherein {w} is a corresponding label on the faceplate of the network device (e.g., D1, D6, L4),
Sl{x} indicates the slot {x}, wherein {x} is a corresponding label on the faceplate of the network device (e.g., 1 or 2);
Un{y} indicates a cassette (or inner unit) {y} hosting port, wherein {y} is a corresponding label on the faceplate of the network device (e.g., 1 or 2).

A craft person would need to read the identifiers, such as Un{v}.Pt{w} and Un{v}.Sl{x}.Un{y}.Pt{w}, from the LCT, and find the corresponding physical ports on the network device (301 and 311 in the example). These operations may require some time and are prone to errors. Instead, a visual indication of the physical ports to connect would reduce time and probability of an error for the craft person. The bottom part of FIG. 3 shows an example of colors assigned according to embodiments to each pair of physical ports to be connected:
green is assigned to Unit1.PtD1 and Unit2.PtD1,
blue is assigned to Un1.PtD6 and Un2.PtD6,
light blue is assigned to Un1.Sl1.Un1.PtL4 and Un2.Sl1.Un1.PtL4.

If the two network devices have a LED associated with each physical port, the color emitted by the LED associated with the physical port identified by the identifiers, will be the assigned one. Alternatively, an augmented-reality device may show the assigned colors overlapping the corresponding physical ports.

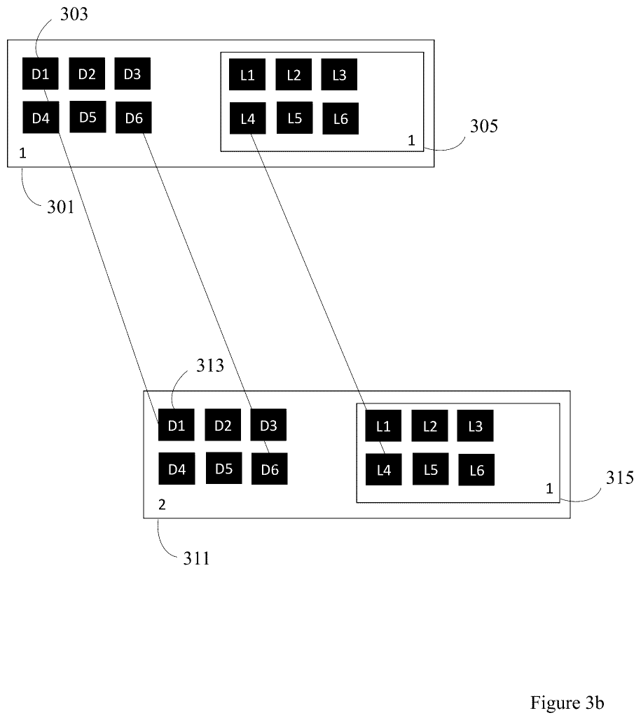

FIG. 4 is a block diagram illustrating one embodiment of a device 400, comprising a processor 401, a computer program product 405 in the form of a computer readable storage medium 406 in the form of a memory 402 and communication circuitry 403.

The memory, 402, contains instructions executable by the processor, 401, such that the device 400, in one embodiment is operative to determine 201 a service, wherein the service requires a multiport connection. The device 400 is further operative to obtain 203 identifiers of the at least two pairs of physical ports 103, 113, and 107, 117 on the two network devices based on the defined service. The device 400 is further operative to send 209 control signals to user interfaces associated with the two network devices 101, 111 to indicate the at least two pairs of physical ports 103, 113, and 107, 117 to be connected based on the obtained physical port identifiers.

The device, 400, may include a processing circuitry (one or more than one processor), 401, coupled to communication circuitry, 403, and to the memory 402. The device, 400, may comprise more than one communication circuitry. For simplicity and brevity only one communication circuitry, 403, has been illustrated in FIG. 4. By way of example, the communication circuitry, 403, the processor(s) 401, and the memory 402 may be connected in series as illustrated in FIG. 4. Alternatively, these components 403, 401 and 402 may be coupled to an internal bus system of the device, 400.

The memory 402 may include a Read-Only-Memory, ROM, e.g., a flash ROM, a Random-Access Memory, RAM, e.g., a Dynamic RAM, DRAM, or Static RAM, SRAM, a mass storage, e.g., a hard disk or solid-state disk, or the like.

The device 400 may be a router, gateway, or any device with computing, storage, and network connectivity to the network devices 101, 111.

The device 400 further comprises a computer program product 405 in the form of a computer readable storage medium 406, which in some embodiments may be implements as a memory 402.

The computer program product 405 comprises a computer program 405, which comprises computer program code loadable into the processor 401, wherein the computer program 404 comprises code adapted to cause the device 400 to perform the steps of the method described herein, when the computer program code is executed by the processor 401. In other words, the computer program 604 may be a software hosted by the device 400.

It is to be understood that the structures as illustrated in FIG. 4 are merely schematic and that the device, 400, may actually include further components which, for the sake of clarity, have not been illustrated, e.g., further interfaces or processors. Also, it is to be understood that the memory, 402, may include further program code for implementing other and/or known functionalities.

It is also to be understood that the device, 400, may be provided as a virtual apparatus. In one embodiment, the device, 400, may be provided in distributed resources, such as in cloud resources. When provided as virtual apparatus, it will be appreciated that the memory, 402, processing circuitry, 401, and communication circuitry, 403, may be provided as functional elements. The functional elements may be distributed in a logical network and not necessarily be directly physically connected. It is also to be understood that the device, 400, may be provided as a single-node device, or as a multi-node system.

In one embodiment the device 400 may be one of the network devices to be connected by the LAG connection. The LCT may be a website interface hosted on this network interface that is accessed via a laptop, tablet or other device with a user interface. The craft person may then set up the LAG connection by logging into the LCT of the network device and the network device operates the method described in embodiments of this invention by the LCT sending instructions to both network devices to indicate the at least two pairs of physical ports to be connected based on the obtained physical port identifiers.

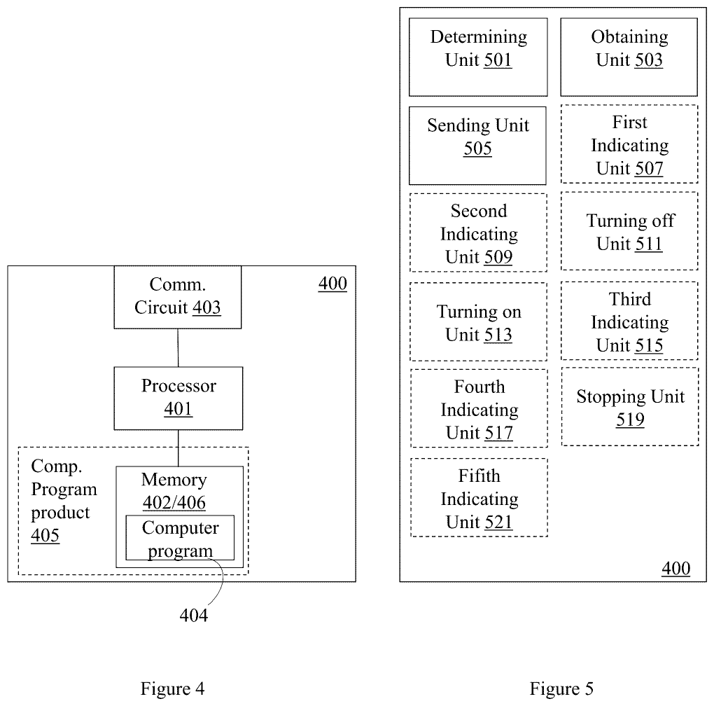

FIG. 5 schematically illustrates, in terms of a number of functional units, the components of a device 400 according to an embodiment. A determining unit 501 is configured to determine 201 a service requiring a multiport connection. An obtaining unit 503 is connected to the determining unit 501 and is configured to obtain 203 identifiers associated with the at least two pairs of physical ports 103, 113, and 107, 117 on the two network devices based on the defined service. The at least two pairs of physical ports 103, 113, and 107, 117 need to be connected to offer the service. A sending unit 505 is connected to the obtaining unit 503 and uses the obtained physical port identifiers to indicate in user interfaces associated with the two network devices 101, 111 the at least two pairs of physical ports 103, 113 and 107, 117 to be connected.

Then the device 400 illustrated in FIG. 5 may optionally further comprise: a first indicating unit 507, a second indicating unit 509, a turning off unit 511, a turning on unit 513, a third indicating unit 515, a fourth indicating unit 517, a stopping unit 519, and a fifth indicating unit 521. The first indicating unit 507 may be connected to the obtaining unit 503 and may be configured to show 207 in a GUI the identifiers and information representing the same LED color for a pair of physical ports 103, 113. The second indicating unit 509 may be connected to the obtaining unit 503 and may be configured to show 205 in the GUI the identifiers and information representing the same LED blink frequency for a pair of physical ports 103, 113. The turning off unit 511 may be connected to the sending unit 505 and is configured to turn off 211 a first pair of LEDs 105, 115 associated with a first pair of physical ports 103, 113 if the physical ports in the first pair are connected; and the turning on unit 513, connected to the turning off unit 511, is configured to turn on 213 a further pair of LEDs 109, 119 associated with a further pair of physical ports 107, 117 to be connected. The third indicating unit 515 may be connected to the sending unit 505 and is configured to show 215 at a same time at least a first graphical indication for a first pair of physical ports 103, 113 to be connected and a second graphical indication for a second pair of physical ports 107, 117 to be connected. Finally, a fourth indicating unit 517 may be connected to the sending unit 505 and configured to show 217 a first graphical indication of a first pair of physical ports 103, 113 until the first pair of physical ports is not connected; a stopping unit 519 may be connected to the fourth indicating unit 517 and configured to stop showing 219 the first graphical indication if the first pair of physical ports 103, 113 is connected; and a fifth indicating unit 521 may be connected to the stopping unit 519 and configured to show 221 a second graphical indication of a second pair of physical ports 107, 117 to be connected.

In general terms, each functional unit 501-521 may be implemented in hardware or in software. Preferably, one or more or all functional modules 501-521 may be implemented by the processor 401, possibly in cooperation with the communications circuitry 403 and the computer readable storage medium 406 in the form of a memory 402. The processor 401 may thus be arranged to from the computer readable storage medium 406 in the form of a memory 402 fetch instructions as provided by a functional unit 501-521 and to execute these instructions, thereby performing any steps of the device 400 as disclosed herein.

1. A method of supporting establishing a connection between at least two pairs of physical ports on two network devices, the at least two pairs of physical ports belonging to a same multiport connection, the method comprising:
determining a service requiring a multiport connection based on at least two pairs of physical ports,
obtaining identifiers of the at least two pairs of physical ports on the two network devices based on the determined service,
sending control signals to user interfaces associated with the two network devices to indicate the at least two pairs of physical ports to be connected based on the obtained physical port identifiers.

2. The method according to claim 1, wherein the user interfaces associated with the two network devices comprise faceplates of the two network devices and the control signals turn on Light Emitting Diodes, LEDs pairwise associated with the at least two pairs of physical ports based on the obtained physical port identifiers.

3. The method according to claim 1, wherein the user interfaces associated with the two network devices comprise at least one augmented-reality device and the operation of sending comprises sending control signals to the at least one augmented-reality device to generate an augmented reality image by overlaying the at least two pairs of physical ports with a graphical indication.

4. The method according to claim 1, wherein the user interfaces associated with the two network devices comprise at least one augmented-reality device and the operation of sending comprises sending control signals to the at least one augmented-reality device to present the at least two pairs of physical ports and a graphical indication if a camera of the at least one augmented-reality device captures the at least two pairs of physical ports.

5. The method according to claim 1, wherein the connection between the at least two pairs of physical ports forms a Link Aggregation Group, LAG.

6. (canceled)

7. The method according to claim 1, wherein the control signals assign a same LED color pairwise to the identifiers.

8. A method according to claim 7, further comprising
showing in a GUI the identifiers and information representing the same LED color.

9.-13. (canceled)

14. A device for supporting a multiport connection, the device comprising a processor and a memory, the memory having stored thereon instructions executable by the processor, wherein the instructions, when executed by the processor, cause the device to:
determine a service requiring a multiport connection based on at least two pairs of physical ports,
obtain identifiers of at least two pairs of physical ports belonging to the multiport connection on two network devices based on the determined service,
send control signals to user interfaces associated with the two network devices to indicate the at least two pairs of physical ports to be connected based on the obtained physical port identifiers.

15. The device according to claim 14, wherein the user interfaces associated with the two network devices comprise faceplates of the two network devices and the control signals turn on LEDs pairwise associated with the at least two pairs of physical ports based on the obtained physical port identifiers.

16. The device according to claim 14, wherein the user interfaces associated with the two network devices comprise at least one augmented-reality device and the operation of sending comprises sending control signals to the at least one augmented-reality device to generate an augmented reality image by overlaying the at least two pairs of physical ports with a graphical indication.

17. The device according to claim 14, wherein the user interfaces associated with the two network devices comprise at least one augmented-reality device and the operation of sending comprises sending control signals to the at least one augmented-reality device to present the at least two pairs of physical ports and a graphical indication if a camera of the at least one augmented-reality device captures the at least two pairs of physical ports.

18. The device according to claim 14, wherein the connection between the at least two pairs of physical ports forms a Link Aggregation Group, LAG.

19. The device according to claim 14, wherein the operation of sending the control signals to the two network devices is carried out by a Local Craft Terminal, LCT.

20. The device according to claim 15, wherein the control signals assign a same LED color pairwise to the identifiers.

21. The device according to claim 20, wherein the instructions, when executed by the processor, cause the device to
show in a GUI the identifiers and information representing the same LED color.

22. The device according to claim 15, wherein the control signals assign a same LED blink frequency pairwise to the identifiers.

23. The device according to claim 22, wherein the instructions, when executed by the processor, cause the device to
show in a GUI the identifiers and information representing the same LED blink frequency.

24. The device according to claim 15, wherein the instructions, when executed by the processor, cause the device to
turn off a first pair of LEDs associated with a first pair of physical ports if the physical ports in the physical ports in the first pair are connected;
turn on a further pair of LEDs associated with a further pair of physical ports to be connected.

25. The device according to claim 16, wherein the instructions, when executed by the processor, cause the device to
showing at a same time at least a first graphical indication for a first pair of physical ports to be connected and a second graphical indication for a second pair of physical ports to be connected.

26. The device according to claim 16, wherein the instructions, when executed by the processor, cause the device to
showing a first graphical indication of a first pair of physical ports until the first pair of physical ports is not connected;
stop showing the first graphical indication if the first pair of physical ports is connected;
showing a second graphical indication of a second pair of physical ports to be connected.

27.-28. (canceled)
